(19) United States
(12) Patent Application Publication
(10) Pub. No.: US 2012/0031823 A1
(43) Pub. Date: Feb. 9, 2012

(54) Apparatus for the Treatment of Wastewater

(75) Inventor: Knud Hamann, Appel (DE)

(73) Assignee: HAMANN AG, Hollenstedt (DE)

(21) Appl. No.: 13/063,634

(22) PCT Filed: Aug. 22, 2009
(86) PCT No.: PCT/EP09/06109

§ 371 Date: Oct. 11, 2011

(30) Foreign Application Priority Data
Sep. 12, 2008 (DE) 10 2008 046 913.0

(51) Int. Cl. C02F 1/00

(52) U.S. Cl. 210/170.11

(57) ABSTRACT

An apparatus for the treatment of wastewater, in particular aboard boats, with a treatment tank, which has a receiving portion and a treatment portion, an intake for wastewater in the receiving portion, an outlet on the treatment portion for treated wastewater, which is connected back into the treatment portion via a maceration pump with an intake for treated wastewater, wherein a separating wall with overflow is arranged between the receiving portion and the treatment portion, the receiving portion has a sump for solids and a connection for sea water and disinfecting agent is provided on the treatment portion, wherein a guide wall is arranged at a distance from the upper intake in the receiving portion, which ends above the sump and first directs the entering wastewater in the direction of the sump, the separating wall with a wall adjacent to the treatment portion forms an intermediate reservoir, to which the wastewater is added via the overflow, wherein the other wall has a second overflow to the treatment portion and the separating wall is designed as a flap, which in the open position connects the lower area of the intermediate reservoir with the sump.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The invention relates to an apparatus for the treatment of wastewater, in particular on boats.

It is required that wastewater from ships and boats not be directed into the ocean without treatment. Various apparatuses for the treatment of wastewater are thus known for ships as well as for boats. Such an apparatus is described for example in DE 100 10 610 C2. The known apparatus has a reservoir or tank, which is divided into two areas, namely into a receiving and a separation reservoir. Both reservoirs are separated by a wall, which forms a lateral gap between the reservoirs on both sides, in order to hold back larger solids in the receiving reservoir. The outlet of the treatment reservoir is in turn connected with itself via a pump and a chopping station in order to provide for the reduction of solids and mixture with a disinfecting agent; in particular, a connection for sea water and one for the disinfecting agent are provided on the treatment reservoir.

An apparatus for the treatment of wastewater also became known from EP 1 726 521 A2, in which several sensors are arranged in the treatment reservoir, which check the fill level in the treatment tank. The wastewater is directed from a storage reservoir by means of a pump into the treatment tank, which can also be supplied with sea water via a pump. Another pump serves to dose a disinfecting agent and a maceration pump guides the treated wastewater in the cycle, wherein the treated wastewater can be directed overboard with the help of a three-way valve.

### BRIEF SUMMARY OF THE INVENTION

The object of the invention is to create an apparatus for the treatment of wastewater, with which a particularly effective treatment can be achieved within a short time.

In the case of the apparatus according to the invention, a guide wall is arranged at a distance from the upper intake in the receiving portion, which ends at a distance above a sump. The arriving wastewater is thereby first directed in the direction of the sump. In this manner, a large amount of solids is already separated out in the sump. The wastewater is directed back into the receiving reservoir below the guide wall and arrives via an overflow in an intermediate reservoir with a preferably sloping side wall, the tilt of which runs in the direction of the receiving reservoir. The separating wall is mounted in a moveable manner, via which in the open position solids deposited in the intermediate reservoir can move into the sump. A further wall situated towards the treatment reservoir is provided with another overflow, via which the wastewater then arrives in the treatment portion. It is displaced with sea water there and is disinfected with a suitable disinfecting agent, e.g. chlorine.

According to one embodiment of the invention, the lower edge of the second overflow lies slightly above the upper edge of the first overflow.

According to another embodiment of the invention, the sump is funnel-shaped so that in the receiving portion the solids can enter the sump in a simple manner and can be conveyed on out of it.

In another embodiment of the invention, the further wall slopes downward so that solids in the intermediate reservoir can slide along this wall in the direction of the sump and arrive in it when the flap is open. The flap is preferably pre-stressed into the closed position by gravitational force and the hydrostatic pressure of the medium.

According to another embodiment of the invention, the first overflow is formed by at least one U-shaped pipe portion, the ends of which point downward. It is especially important that the overflow into the intermediate reservoir creates a flow downward so that the flow is forced to flow into the lower area of the intermediate reservoir and return upward to the overflow to the treatment portion.

At least one sensor, which is connected with a controller for the apparatus according to the invention, which controls the individual pumps and valves according to the requirements of a specified program, is arranged in the treatment portion. The sensor determines when wastewater is approaching, in order to add, which is generally known, sea water and a disinfecting agent, for example chlorine. In the case of the apparatus according to the invention, the treated wastewater can also be circulated via a mixer and a maceration pump in order to reduce the still present solids.

The inflow to the receiving portion takes place via a pump, wherein a preliminary reservoir is preferably provided, into which the wastewater accumulating on the boat can be directed.

One exemplary embodiment of the invention is explained below in greater detail using a drawing.

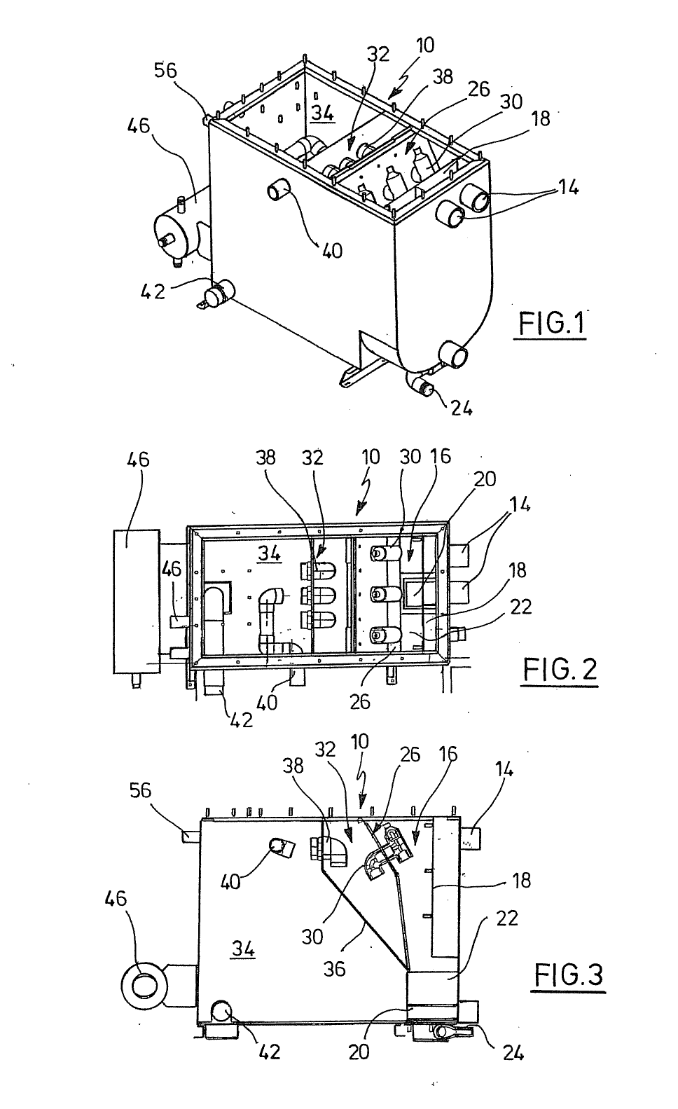

FIG. 1 shows a perspective view diagonally from above of a treatment tank of an apparatus according to the invention.

FIG. 2 shows a top view of the representation according to FIG. 1.

FIG. 3 shows a cut through the representation according to FIG. 2 along line 3-3.

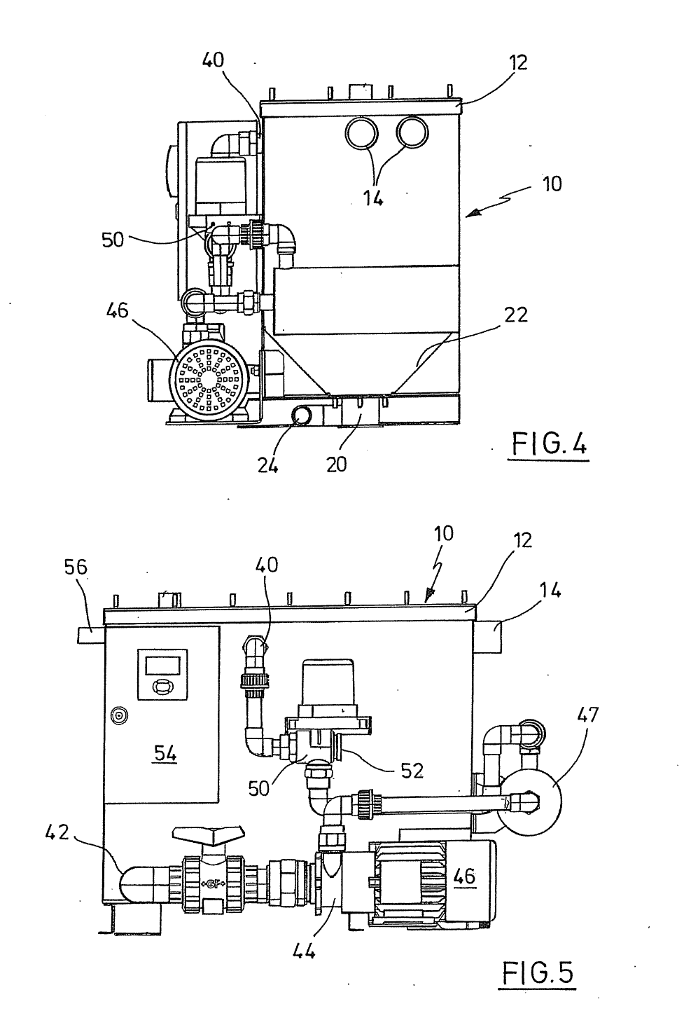

FIG. 4 shows an end view of the treatment tank according to FIG. 1 with attached aggregates.

FIG. 5 shows the side view of the representation according to FIG. 5.

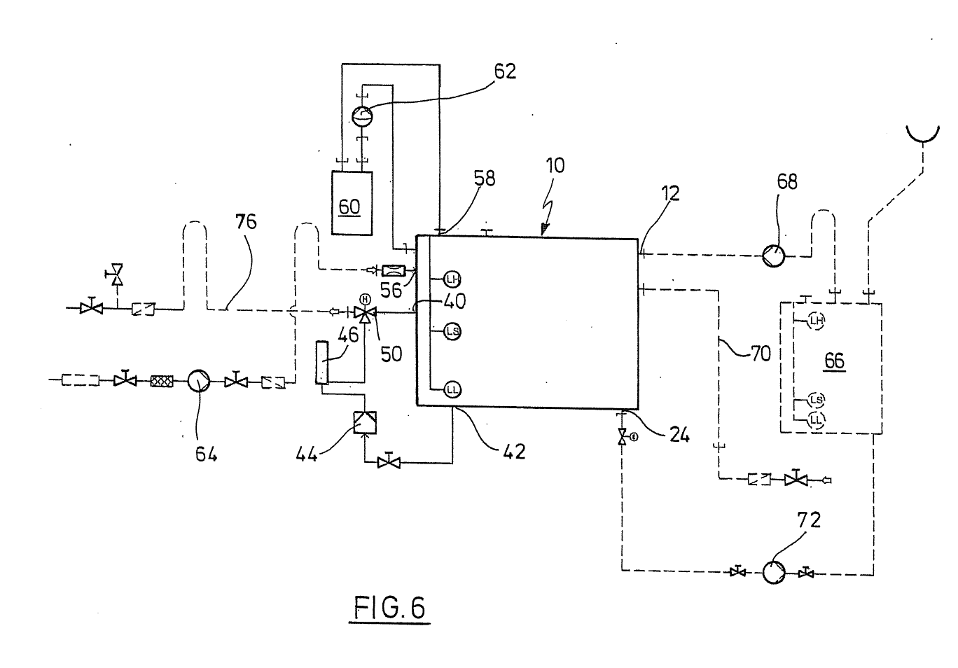

FIG. 6 shows a circuit diagram for the apparatus according to the FIGS. 1 through 5.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

FIGS. 1 through 5 show a treatment tank 10, which is open in FIGS. 1 through 3 and closed by a cover 12 in FIGS. 4 and 5. The treatment tank is mainly square-shaped.

Two inlets 14 for wastewater are arranged in the upper end area on the right end in FIGS. 1 through 3. They are connected with a receiving portion 16 in the treatment tank 10. A guide wall 18, which ends at a distance above the bottom of the treatment tank 10, is arranged parallel and at a distance from the end wall of the treatment tank 10. A sump 20 is arranged below the guide wall 18. The wastewater flowing in over the intakes 14 hits the guide wall 18 and is directed downward. It can then turn around on the lower end of the guide wall and flow upward into the receiving area 16. Towards sump 20, inclined planes 22 are formed, which form a type of funnel in the direction of the sump 20. The sump 20 is connection with a connection 24, via which solids can be transported away. At a distance from the guide wall 18, a separating wall 26, which is designed as a flap that can swing open to the right, is arranged in the treatment tank 10 for restricting the receiving area 16. The flap is arranged slightly sloped so that it is pre-stressed by gravitational force in connection with the hydrostatic pressure of the filled receiving area 16 into the closed position shown in FIG. 3. In the upper area of the separating wall 26, three U-shaped pipe portions 30 are arranged such that they ensure an overflow of the liquid from the receiving portion 16 to an intermediate reservoir 32 with an outlet pointing downward in a sloping manner, which is separated from a larger treatment portion 34 by a wall 36. The wall 36 extends in the lower area downward in a sloped manner in the direction of wall 26, so that a part with a triangular cross-section is formed between them. Solids can slide downward along the wall 36 and reach sump 20 when the wall 26 is open.

In the upper vertical area of wall 36, three spaced angled pipe pieces 38 are arranged as overflow into the treatment portion 34. The lower edge of the overflow 38 lies slightly above the lower edge of the overflow formed by the pipe pieces 30.

In FIGS. 1 through 3, an outlet 42 can be seen in the lower rear area of the receiving portion 34 and in the upper area an intake 40, which is covered in greater detail below.

As can be seen in FIG. 5, the outlet 42 is connected via a maceration pump 44, which is driven by a motor 46, and a vortex mixer 47, from which liquid is directed back into the intake 40. In the connection to the intake, a three-way valve 50 is arranged, which connects it optionally with an outlet 52, via which treated wastewater can be directed overboard.

A housing or a terminal box 54 for an electrical connection to the control device, which will be briefly explain below in terms of FIG. 6, is arranged outside on the treatment tank 10.

It is also noted that sea water can be directed into the treatment portion 34 via an intake 56 and a disinfecting agent, e.g. chlorine, via an outlet 58.

FIG. 6 shows a reservoir 60 for a disinfecting agent, which is directed into the treatment tank 10 via a dosing pump 62. A pump 64 directs sea water via a corresponding line via the intake 56 into the treatment portion 34.

A pump 68 directs wastewater 68 to the intakes 12 from a collecting tank 66 for wastewater. Fresh water can be directed into the receiving portion 16 via a line 70. A sludge pump 72 conveys sludge from the sump 20 and via the outlet 24 to the reservoir 66. A line 74 is connected with the three-way valve 50 in order to direct treated water overboard.

The shown pumps and valves are connected by the controller, not shown in greater detail, which is connected with the terminal box 54 (FIG. 5).

During operation, a certain amount of wastewater is either directed into the receiving portion 16 either with the help of the pump 68 or through gravitational force, namely via inlets 14. The inflowing wastewater flows against the guide wall 18 and is thereby forced downward in the direction of sump 20 so that a large amount of solids can already be deposited in the sump 20. The flow around the guide wall 18 is then directed upward into the receiving portion 16. With the help of the overflow 30, the water collecting above the overflows is then directed into an intermediate reservoir 32, wherein the flow is directed downward into the area, which is formed by the wall 26 and the wall 36. Further solids are thereby separated and also arrive in the sump 20 when the flap is open. Liquid that is mainly free of solids is directed into the treatment portion 34 via the overflow 38, wherein a sensor (not shown) determines whether liquid is in the treatment portion 34. If this is the case, sea water is added to the treatment portion 34 via the pump 64 and directed into this portion by means of dosing pump 60, e.g. chlorine. The maceration pump 44 ensures the circulation of the liquid from the treatment portion 34 via a vortex mixer 46 and the pump 44. After a certain period of time, the valve 50 will be switched and the liquid will be directed overboard out of the treatment portion 34 via the outlet 52.

The described cycle for a batch of wastewater takes approximately six minutes. Subsequently, a new batch of wastewater can be added to the treatment portion 16.

This completes the description of the preferred and alternate embodiments of the invention. Those skilled in the art may recognize other equivalents to the specific embodiment described herein which equivalents are intended to be encompassed by the claims attached hereto.

1. An apparatus for the treatment of wastewater, in particular aboard boats, with a treatment tank, which has a receiving portion and a treatment portion, an intake for wastewater in the receiving portion, an outlet on the treatment portion for treated wastewater, which is connected back into the treatment portion via a maceration pump with an intake for treated wastewater, wherein a separating wall with overflow is arranged between the receiving portion and the treatment portion, the receiving portion has a sump for solids and a connection for sea water and disinfecting agent is provided on the treatment portion, characterized in that a guide wall (18) is arranged at a distance from the upper intake (14) in the receiving portion (16), which ends above the sump (20) and first directs the entering wastewater in the direction of the sump (20), the separating wall (26) with a wall (36) adjacent to the treatment portion (34) forms an intermediate reservoir (32), to which the wastewater is added via the overflow (30), wherein the other wall (36) has a second overflow (38) to the treatment portion (34) and the separating wall (24) is designed as a flap, which in the open position connects the lower area of the intermediate reservoir (32) with the sump (20).

2. The apparatus according to claim 1, characterized in that the lower edge of the second overflow (38) lies slightly above the lower edge of the first overflow (30).

3. The apparatus according to claim 1, characterized in that the sump is funnel-like.

4. The apparatus according to claim 1, characterized in that the other wall (36) approaches the separating wall (28) downward in a sloped manner.

5. The apparatus according to claim 1, characterized in that the separating wall as a flap is held in its closed position through gravitational force in connection with the hydrostatic pressure of the filled receiving area (16).

6. The apparatus according to claim 1, characterized in that the first overflow is formed by at least one U-shaped pipe portion (30), the lower ends of which point downward.

7. The apparatus according to claim 1, characterized in that the second overflow is formed by at least one angled pipe portion (38).

8. The apparatus according to claim 1, characterized in that a sensor is arranged in the treatment portion (34), which determines when a certain amount of liquid is located in the treatment portion (34) for the purpose of introducing sea water and/or disinfecting agent into the treatment portion (34).

9. The apparatus according to claim 1, characterized in that a maceration pump (44) with drive motor (46), a vortex mixer (46) as well as pipe connections are attached outside on the treatment portion (34).
